(19) United States
(12) Patent Application Publication
(10) Pub. No.: US 2018/0027601 A1
(43) Pub. Date: Jan. 25, 2018

(54) COMMUNICATION APPARATUS, METHOD OF CONTROLLING THE SAME, AND NON-TRANSITORY COMPUTER-READABLE STORAGE MEDIUM

(71) Applicant: CANON KABUSHIKI KAISHA, Tokyo (JP)

(72) Inventor: Toshifumi Hamachi, Kawasaki-shi (JP)

(21) Appl. No.: 15/635,295

(22) Filed: Jun. 28, 2017

(30) Foreign Application Priority Data
Jul. 25, 2016 (JP) 2016-145695

(51) Int. Cl. H04W 76/02; H04W 8/00

(52) U.S. Cl. CPC H04W 76/023; H04W 8/005; H04W 84/12

(57) ABSTRACT

A communication apparatus, in a first period which is a Discovery Window defined in Neighbor Awareness Networking (NAN), in a case when a signal for searching for a predetermined service or a reply corresponding to the signal is communicated with another communication apparatus, determines whether there is a communication parameter that was shared with the other communication apparatus, in a case when it is determined by the determination unit that there is a communication parameter shared with the other communication apparatus, uses the shared communication parameter to establish a data link with the other communication apparatus, and, in a second period including a period different to the first period, executes the predetermined service by the data link.

### BACKGROUND OF THE INVENTION

### Field of the Invention

The present invention relates to a communication apparatus, a method of controlling the same, and a non-transitory computer-readable storage medium.

### Description of the Related Art

A wireless LAN system as typified by IEEE 802.11 is widely used. In a wireless LAN, a network is controlled by a base station called an access point (AP). A wireless network is configured by this AP and a station that is present within the coverage area of the AP and is in a wireless connection state. In recent years, in addition to simple wireless network configurations according to these kinds of conventional APs and STAs, various wireless LAN network configuration products and specification standards are appearing.

In U.S. Patent Application Publication No. 2014/302787, Neighbor Awareness Networking (NAN) which is defined by the Wi-Fi Alliance is recited as a standard of communication for detecting a communication apparatus and services and the like that the communication apparatus provides with reduced power consumption. In an NAN, the communication apparatuses which configure the NAN (hereinafter, NAN devices) synchronize a period in which information is exchanged. Note that the Wi-Fi Alliance has certified NAN under the title Wi-Fi Aware. Using this, a time over which a wireless RF is made to be active can be shortened and power savings can be realized. In the NAN, a period for the synchronization is called a Discovery Window (DW). Also, a collection of NAN devices among which a predetermined synchronization period is shared is called an NAN cluster.

The NAN device can handle any of the roles such as Master, Non-Master Sync, and Non-Master Non-Sync within the NAN cluster. An NAN device that has the role of Master transmits a Sync Beacon, which is a signal for making each NAN device of the same NAN cluster synchronize, in a DW period. Also, the NAN devices within the NAN cluster transmits/receives Publish messages, which are signals for notifying that a service is provided, or Subscribe messages, which are signals for searching for a service, with each other in the DW period after having synchronized. Furthermore, each NAN device can exchange Follow-up messages for exchanging additional information relating to a service in the DW period. A frame configuration of a message such as a Publish message, a Subscribe message, or a Follow-up message is defined by the NAN standard and is called a Service Discovery Frame (SDF). In an SDF, a Service ID, which is an identifier for identifying a target service, is included. Detection of a service can be performed by NAN devices mutually exchanging SDFs.

Detection of a service can be performed by NAN devices by the above described method in an NAN cluster. However, the NAN device must separately establish a wireless connection in the case of performing application communication in order to execute a service after detecting a service. Communication for implementing a service is performed by a network other than an NAN cluster, specifically a network other than an NAN such as an Infra network, an IBSS, Wi-Fi Direct or the like. The NAN device is able to establish a new network and communicate by an application. However, conventionally, there has been a problem in that it has been necessary to perform processing for communicating by a separate, new network, and it has not been possible to start communication for execution of a service quickly.

### SUMMARY OF THE INVENTION

According to one aspect of the present invention, there is provided a communication apparatus which comprises: a determination unit configured to, in a first period which is a Discovery Window defined in Neighbor Awareness Networking (NAN), in a case when a signal for searching for a predetermined service or a reply corresponding to the signal is communicated with another communication apparatus, determine whether there is a communication parameter that was shared with the other communication apparatus; a data link control unit configured to, in a case when it is determined by the determination unit that there is a communication parameter shared with the other communication apparatus, use the shared communication parameter to establish a data link with the other communication apparatus; and an execution unit configured to, in a second period including a period different to the first period, execute the predetermined service by a data link established by the data link control unit.

Further features of the present invention will become apparent from the following description of exemplary embodiments (with reference to the attached drawings).

### BRIEF DESCRIPTION OF THE DRAWINGS

FIG. 1 illustrates a wireless network configuration in an embodiment.

FIG. 2 illustrates an example of a functional configuration of an NAN device in an embodiment.

FIG. 3 illustrates an example of a hardware configuration of an NAN device in an embodiment.

FIG. 4 is a flowchart of communication link establishment processing in a first embodiment.

FIG. 5 is the sequence diagram for illustrating processing in the first embodiment.

FIG. 6 is a flowchart of communication link establishment processing in a second embodiment.

FIG. 7 is the sequence diagram for illustrating processing in the second embodiment.

FIG. 8 is a flowchart of communication link establishment processing in a third embodiment.

FIG. 9 is the sequence diagram for illustrating processing in the third embodiment.

### DESCRIPTION OF THE EMBODIMENTS

### First Embodiment

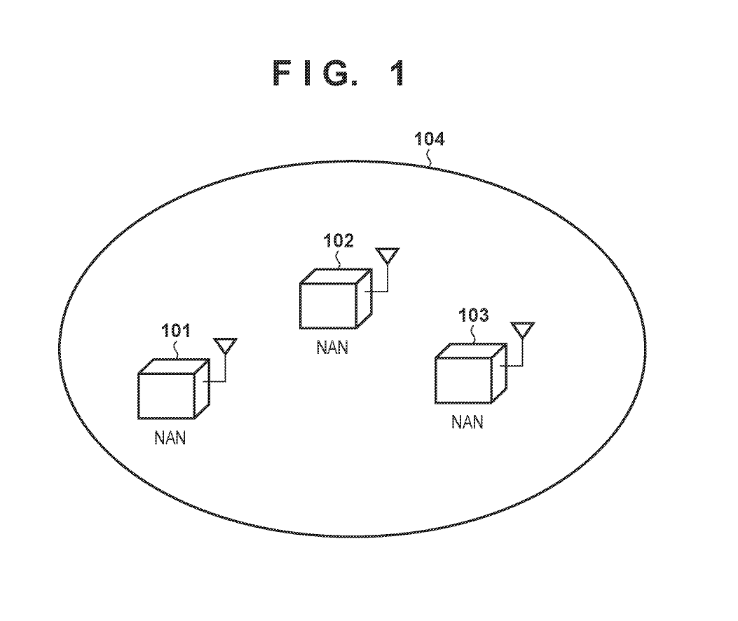

FIG. 1 illustrates a network configuration example in the present embodiment. Hereinafter, description will be given regarding an example which uses a wireless LAN system conforming to the Neighbor Awareness Networking (NAN) standard. In the NAN, service information is communicated in a period called a Discovery Window (DW). DW is a time and channel at which a plurality of devices that execute NAN converge. Also, a set of terminals sharing a DW schedule are referred to as an NAN cluster. Note that a DW is generated at a fixed period.

Each terminal (NAN device) belonging to an NAN cluster operates in a role of either Master, Non-Master Sync, and Non-Master Non-Sync. A terminal that operates as Master transmits a Synchronization Beacon (hereinafter referred to as Sync Beacon) which is a beacon for each terminal to identify the DW and synchronize. Also, a terminal that operates as Master transmits a Discovery Beacon which is a signal for causing a terminal that does not belong to an NAN cluster to recognize the NAN cluster. The Discovery Beacon is transmitted every 100 ms, for example, outside of the DW period. Note that in each NAN cluster at least one terminal operates as Master.

A terminal operating as Non-Master Sync transmits a Sync Beacon, but does not transmit a Discovery Beacon. A terminal operating as Non-Master Non-Sync transmits neither a Sync Beacon nor a Discovery Beacon.

A terminal participating in an NAN cluster communicates service information in the DW period by synchronizing to the DW period every predetermined cycle in accordance with the Sync Beacon.

The terminals, to each other, communicate, in a DW period, Subscribe messages which are signals for detecting or requesting a service and Publish messages which are signals for notifying that a service is being offered. Furthermore, each terminal can exchange Follow-up messages for exchanging additional information relating to a service in a DW period. Note that, the Publish, Subscribe and Follow-up messages are collectively referred to as Service Discovery Frames (SDF). Each terminal can perform service advertisement and detection by exchanging SDFs.

Also, each terminal participating in an NAN cluster communicates on channel 6 (2.437 GHz) of a 2.4 GHz frequency band. In the NAN cluster, a 16TU DW is arranged every 512TU (Time Unit, 1TU is 1024 μsec). That is, in the NAN cluster, a 16TU DW is arranged repeating every 512TU. Each terminal participating in the NAN cluster synchronizes the DW schedule by a Sync Beacon transmitted/received in the DW. Each terminal belonging to an NAN cluster communicates service information by an SDF in each DW period.

Also, in an NAN, performing service or application detection, and establishing a wireless connection for executing the service or application is referred to as PostNAN. In PostNAN, a network other than an NAN cluster, specifically a network other than NAN such as an Infra network, an IBSS, Wi-Fi Direct or the like is established. The NAN device is able to establish a new network and communicate by an application.

NAN devices 101, 102, and 103 are wireless communication apparatuses that perform wireless communication conforming to the NAN standard. Note, the NAN devices 101, 102, and 103 may be any apparatus if capable of joining an NAN and capable of performing communication by an application. The NAN devices 101, 102, and 103, based on the NAN standard, are capable of discovering a communication apparatus in the periphery and services provided thereby, and are capable of providing services. In FIG. 1, the NAN devices 101, 102, and 103 have joined an NAN cluster 104. The NAN devices 101 and 103 have joined the NAN cluster 104 as Non-Master Sync and the NAN device 102 has joined the NAN cluster 104 as Master and Anchor Master. In the present embodiment, the NAN device 101 is a Subscriber which searches for a predetermined service. Also, the NAN device 103 is a Publisher capable of providing a predetermined service that the NAN device 101 searches for.

The NAN cluster 104 is a network that the NAN devices 101, 102, and 103 have joined. In the present embodiment, NAN devices which have joined the NAN cluster 104 construct a network on channel 6. Within the network of the NAN cluster 104, the Discovery Window (DW) is 16TU (Time Unit), and there is an interval of 512TU from the head of a DW to the head of the next DW. Note that configuration of the DW and the wireless channel of the NAN are not limited to these.

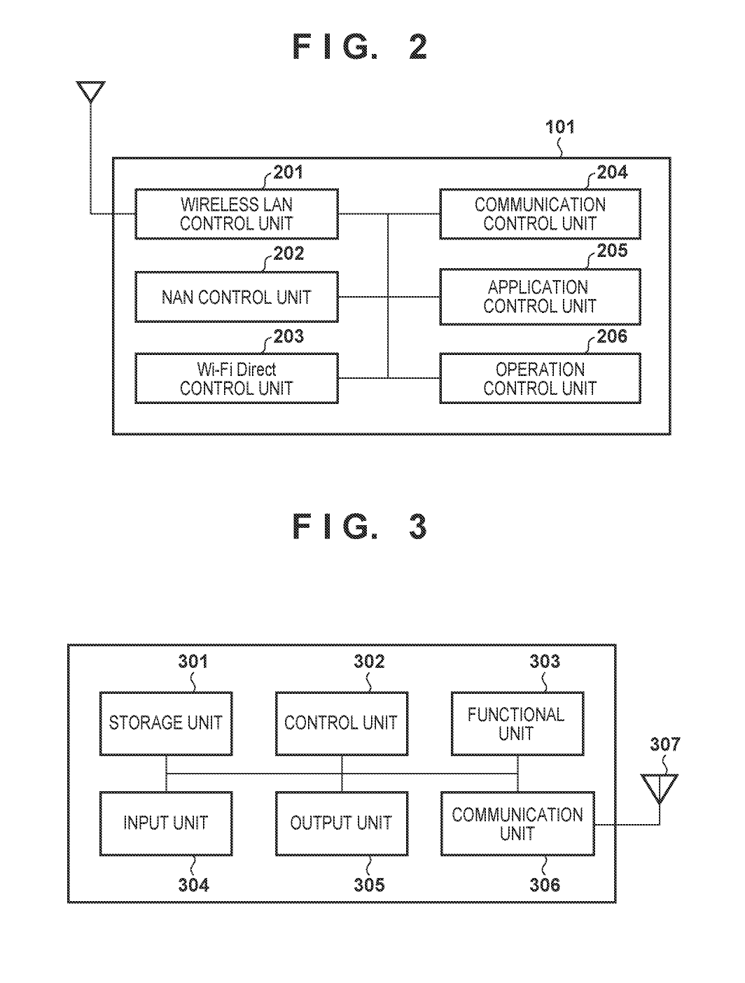

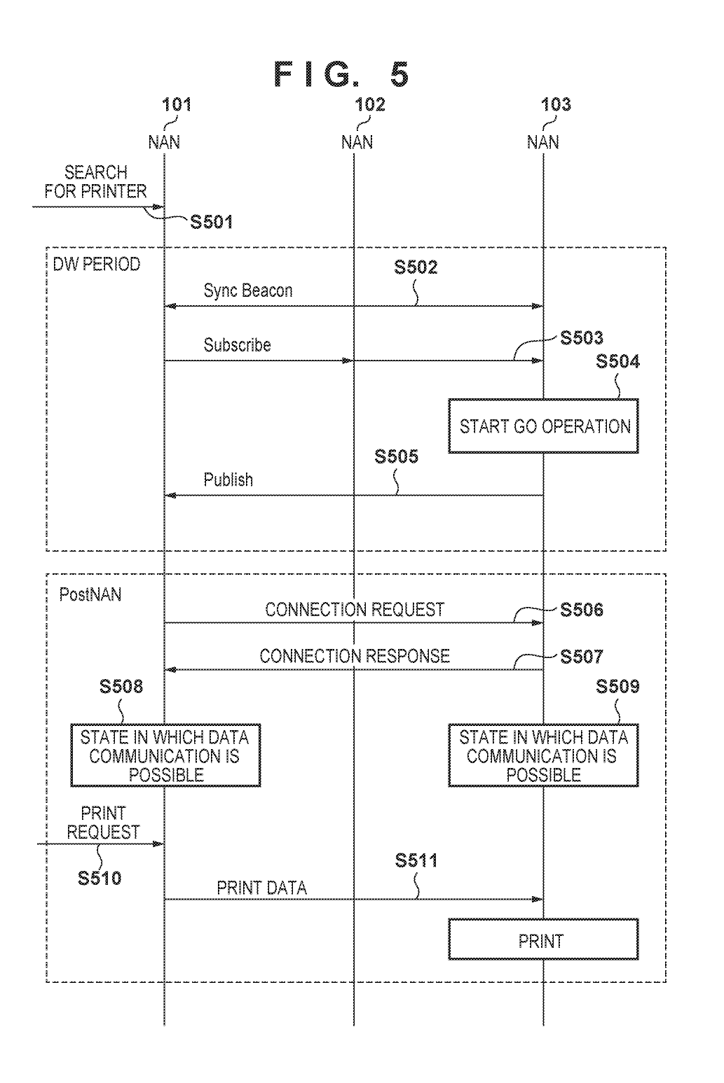

FIG. 2 illustrates an example of a functional configuration of the NAN device 101. Note, the functional configuration of the NAN devices 102 and 103 is the same as that of the NAN device 101. A wireless LAN control unit 201 performs control for transmission/reception of wireless signals with another apparatus having a wireless LAN function. Also, the wireless LAN control unit 201 performs control of the wireless LAN in accordance with IEEE 802.11. An NAN control unit 202 performs control in accordance with the NAN standard. A Wi-Fi Direct control unit 203, by controlling the wireless LAN control unit 201, performs control for establishing a communication link by Wi-Fi Direct. When a data link layer is established by processing of the Wi-Fi Direct control unit 203, the NAN device 101 is enabled to perform data communication by an application. In the present embodiment, as an example, after a data link is established, the NAN device 101 becomes capable of communication by IPv4. Detailed processing of the data link control including data link establishment is described later using FIG. 4 and FIG. 5.

A communication control unit 204 controls communication by the application using a data link layer established by the Wi-Fi Direct control unit 203. By controlling the communication control unit 204, the NAN device 101 is able to perform transmission/reception of IPv4 packets (specifically, communication of application data). Detailed processing of communication of application data is described later using FIG. 4.

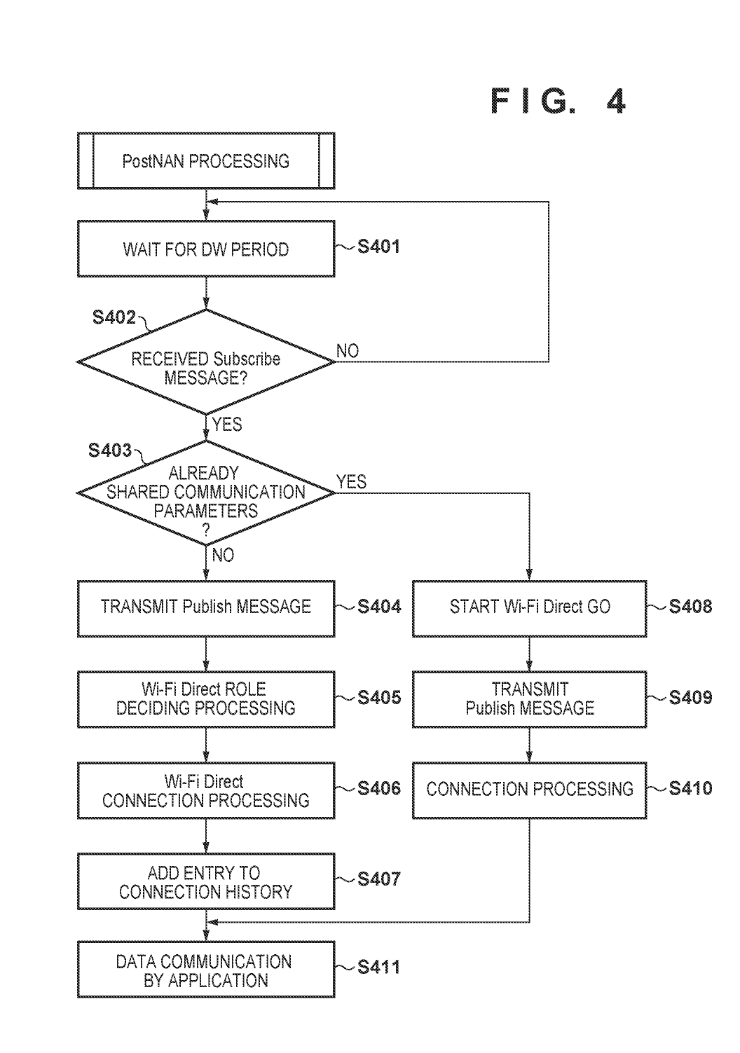

An application control unit 205 performs control for executing a service discovered in the NAN. For example, if the NAN device 101 discovers a print service, the application control unit 205 performs control for executing an application for requesting a print job. Alternatively, if the NAN device 101 discovers a photograph sharing service, the application control unit 205 performs control for executing an application for exchanging photograph data. The NAN device 101 can search for a plurality of services and can have a plurality of the application control unit 205. In the present embodiment, as an example, it is assumed that a print application is executed as an application between the NAN device 101 and the NAN device 103. Also, in the present embodiment, it is assumed that the print application is performed via communication using IPv4. An operation control unit 206 manages operations performed in relation to an input unit 304 (FIG. 3) by the user of the NAN device 101, and transmits necessary signals to the other control units 201-205.

FIG. 3 illustrates an example of a hardware configuration of the NAN device 101. Note, the hardware configuration of the NAN devices 102 and 103 is similar to that of the NAN device 101. A storage unit 301 may be configured by both a ROM (Read Only Memory) and a RAM (Random Access Memory) or by one of them, and stores programs for performing various operations described later and various kinds of information such as communication parameters for wireless communication. Note, other than a memory such as a ROM and a RAM, a storage medium such as a flexible disk, a hard disk, an optical disc, a magneto-optical disk, a CD-ROM, a CD-R, a magnetic tape, a non-volatile memory card, and a DVD may be used as the storage unit 301.

A control unit 302 is configured by a CPU (Central Processing Unit) or an MPU (Micro Processing Unit) and controls the entire NAN device 101 by executing a program stored in the storage unit 301. Note, the control unit 302 may control the entire NAN device 101 by cooperation between a program stored in the storage unit 301 and an OS (Operating System). Also, the control unit 302 controls a functional unit 303 to execute predetermined processing such as imaging, printing, or projecting.

The functional unit 303 is hardware for the NAN device 101 to execute predetermined processing. For example, if the NAN device 101 is a camera, the functional unit 303 is an image capturing unit and performs image capturing processing. For example, if the NAN device 101 is a printer, the functional unit 303 is a print unit and performs print processing. For example, if the NAN device 101 is a projector, the functional unit 303 is a projection unit and performs projection processing. Data that the functional unit 303 processes may be data stored in the storage unit 301 and may be data which is communicated with another NAN device via a communication unit 306 described later.

The input unit 304 performs acceptance of various operations from the user. An output unit 305 performs various output to the user. Here, output by the output unit 305 contains at least one display on a screen, audio output by a speaker, a vibration output or the like. Note, both the input unit 304 and the output unit 305 may be realized by a single module as with a touch panel.

The communication unit 306 performs control of wireless communication conforming to the IEEE 802.11 series and control of IP (Internet Protocol) communication. Also, the communication unit 306 controls an antenna 307 to perform transmission/reception of wireless signals for wireless communication. The NAN device 101 communicates content such as image data, document data, and video data with other NAN devices via the communication unit 306.

Next, with reference to FIG. 4, processing in which the NAN device 103 requests a PostNAN communication link establishment is described. FIG. 4 is a flowchart of communication link establishment processing in the present embodiment. The flowchart illustrated in FIG. 4 is realized by the control unit 302 of the NAN device 103 executing a control program stored in the storage unit 301, and executing control of each piece of hardware as well as information calculation and processing. Note that configuration may be taken such that some or all of the steps illustrated in the flowchart illustrated in FIG. 4 are realized by hardware such as an ASIC, for example.

In the present embodiment, based on the network configuration described using FIG. 1, firstly, the NAN device 103 which provides a print service waits for a print service search from another NAN device in the NAN cluster 104. Then, the NAN device 103 receives a service discovery request, starts operation as a GO (Group Owner) in Wi-Fi Direct, and transmits a service discovery response. The NAN device 101, having received the service discovery response, starts operation as a CL (Client) in Wi-Fi Direct, connects to the network that the GO constructed, and performs print application communication. Below, description is given as processing of the NAN device 103, but it is possible for the other NAN devices of the NAN cluster 104 to perform similar processing.

Note that in the present embodiment, it is assumed that it is possible for connection history in which entries are registered to be stored in the storage unit 301 of the NAN device 103 as information of a device to which the NAN device 103 connected in the past and information related to a connection. In entries registered in the connection history, specifically, an identifier by which it is possible to identify a device such as a MAC address, communication parameters used in communication, and an identifier of a provided service or a received service, or the like are included.

Firstly, the NAN control unit 202 of the NAN device 103 waits until it receives a Subscribe message during the periodic DW period in the NAN cluster 104 (step S401 and step S402). Here, it is assumed that the NAN device 103 waits for reception of a Subscribe message in which a Service ID corresponding to a print application service is designated as the Service ID which identifies the service in an SDF. Also, information indicating that an NAN device that can establish a data link by Wi-Fi Direct is being searched may be included in the Subscribe message.

When the NAN control unit 202 of the NAN device 103 determines that a Subscribe message is received via the communication unit 306 (Yes in step S402), the processing advances to step S403. In step S403, the NAN control unit 202 determines whether or not communication parameters have already been shared with the other NAN device that transmitted the Subscribe message. Specifically, the NAN control unit determines whether or not a history of connection with the other NAN device that transmitted the Subscribe message is stored in the storage unit 301.

If the NAN control unit 202 determines that the communication parameters have already been shared with the other NAN device (Yes in step S403), the Wi-Fi Direct control unit 203 starts operation as GO in Wi-Fi Direct (step S408). At that time, since the NAN device 103 has already constructed a network by executing communication in the past with the other NAN device, the state is such that it is possible to accept the connection from the other NAN device.

When the Wi-Fi Direct control unit 203 completes GO activation, the NAN control unit 202 transmits a Publish message to the other NAN device via the communication unit 306 (step S409). Note that in the SDF of the Publish message that is transmitted, a Service ID corresponding to the print application service is designated as the Service ID that identifies the service. Also, the NAN control unit 202, by adding a P2P Operation attribute to the Publish message that is transmitted, can notify the period, channel, and operating roles (GO, CL, P2P Device) in which communication by Wi-Fi Direct is possible. Also, the NAN control unit 202 can store a value indicating operation as GO in the Publish message that is transmitted.

The other NAN device, having received the Publish message, recognizes that the NAN device 103 is operating as GO. Then, the other NAN device executes processing for connecting with the NAN device 103 as CL by transmitting a connection request. The NAN control unit 202 of the NAN device 103 receives the connection request from the other NAN device via the communication unit 306 and executes connection processing (step S410).

When the connection processing succeeds, the NAN device 103 is enabled to perform communication by the print application, and is enabled to execute printing in accordance with reception of print data from the other NAN device. The communication control unit 204 of the NAN device 103 starts data communication by the application (step S411). The application control unit 205 performs control for executing the application. Note that, if the connection processing fails in step S410, the NAN control unit 202 may try the connection processing again after a fixed period has elapsed.

Meanwhile, if the NAN control unit 202, in step S403, determines that the communication parameters have not yet been shared with the other NAN device that transmitted the Subscribe message (No in step S403), it performs communication parameter sharing processing. Firstly, the NAN control unit 202 transmits a Publish message via the communication unit 306 (step S404). At that point in time, the NAN device 103 has not decided whether to operate as GO or CL, and so it stores a value indicating operation as a P2P Device in the Publish message that is transmitted.

The other NAN device, having received the Publish message, recognizes that the NAN device 103 is operating as a P2P Device. Then, the Wi-Fi Direct control unit 203 executes Wi-Fi Direct role deciding processing (GO Negotiation) with the other NAN device (step S405).

When the roles of the NAN device 103 and the other NAN device are decided through Wi-Fi Direct role deciding processing, the Wi-Fi Direct control unit 203 of the NAN device 103 executes connection processing in the decided role (step S406). After the connection processing completes, the Wi-Fi Direct control unit 203 registers an entry in the connection history stored in the storage unit 301 as information of the connection with the other NAN device (step S407). When the registration of the connection history completes, the NAN device 103 is able to communicate by the print application.

In FIG. 5 in the present embodiment, a flow of a sequence of service discovery, an establishment of a data link by Wi-Fi Direct, and application communication processing is illustrated in a sequence diagram. A situation in which processing for the NAN device 101 searching for a printer by a print application as a Subscriber, and the NAN device 103 waiting for the print service as a Publisher is executing is envisioned. The NAN device 102 is assumed to be causing an application other than the print application to operate.

Firstly, the user of the NAN device 101 inputs an instruction to perform a search for the print service via the input unit 304 (step S501). In accordance with this, the operation control unit 206 of the NAN device 101 starts processing for performing the print service search in relation to the NAN control unit 202. The NAN device 102 notifies the DW period in a Sync Beacon (step S502). The NAN device 101 does not transmit messages until the DW period, even if the search process has started.

The NAN device 101 transmits by a broadcast a Subscribe message in order to search for a printer when the DW period comes (step S503). The NAN device 103 references the history of connection with the NAN device 101 when it receives a Subscribe message in which it is indicated that the print service is being searched. The NAN device 103, by referencing the connection history, recognizes that it operated as GO in the past with the NAN device 101, and starts operation as GO (step S504).

The NAN device 103, having started operation as GO, replies to the NAN device 101 with a Publish message indicating that the print service is operating (step S505). It is possible to include information that the NAN device 103 is operating as GO and a period in which communication by Wi-Fi Direct is possible (a period other than the DW period) in the Publish message.

The NAN device 101, having received the Publish message, recognizes that the NAN device 103 is operating as GO, and starts operation as CL. Then, the NAN device 101, by using the communication parameters used when performing communication with the NAN device 103 in the past, transmits a connection request (step S506). Also, the NAN device 101, by referencing information of the period in which communication is possible that was added to the received Publish message, can transmit a connection request in the period in which the NAN device 103 can reply by Wi-Fi Direct.

The NAN device 103 receives the connection request from the NAN device 101, and if the request is permitted, transmits a connection response (step S507). The NAN device 103, if a connection with the NAN device 101 cannot be allowed, transmits a connection response indicating rejection. Meanwhile, if the connection with the NAN device 101 can be allowed, the NAN device 103 transmits an affirmative connection response and executes processing for key exchange necessary for encrypted communication.

By this, the NAN device 101 and the NAN device 103 enter a state in which data communication by Wi-Fi Direct is possible (step S508 and step S509). When, in this state, the user makes an instruction, via the input unit 304 in the NAN device 101, to the print application to print, print data is transmitted to the NAN device 103, and printing is executed on the NAN device 103 (step S510 and step S511). Here, the NAN device 101 may transmit print data that is designated by the user via the input unit 304 or print data that is decided in advance. Also, the NAN device 101 may transmit print data designated from the NAN device 103 or another apparatus.

In this way, by virtue of the present embodiment, by using past connection history information, it becomes possible to simplify the procedure (terminal discovery, wireless parameter exchange, or the like) for establishing a PostNAN network. Thus, for example, in a case of executing a service a number of times on the same apparatus (printer) such as a print application, it is possible to omit a repeated procedure for establishing the PostNAN network and the service is thereby executed more quickly.

### Second Embodiment

In the second embodiment, the NAN device 101 as a Subscriber, after receiving a Publish message from the NAN device 103 as a Publisher, performs a negotiation through Invitation Request transmission/Response reception. The NAN device 101 and the NAN device 103 decide the communication parameters that are to be used in the PostNAN by this negotiation. Hereinafter, points that are different to the first embodiment are described.

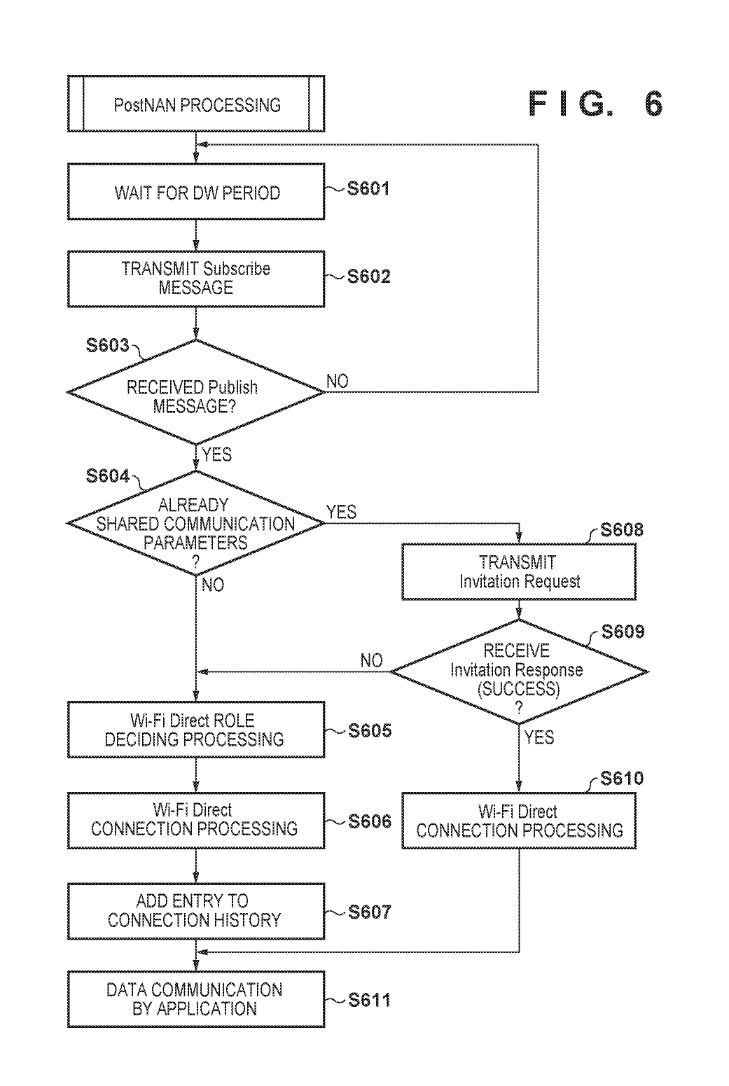

Next, with reference to FIG. 6, processing in which the NAN device 101 requests a PostNAN communication link establishment is described. FIG. 6 is a flowchart of communication link establishment processing in the present embodiment.

The NAN device 101 waits for the periodic DW period in the NAN cluster 104 (step S601). When the DW period comes, the NAN control unit 202 of the NAN device 101 transmits the Subscribe message in a broadcast via the communication unit 306 (step S602). Here, it is assumed that the NAN device 101 transmits a Subscribe message in which a Service ID corresponding to a print application service is designated as the Service ID which identifies the service in an SDF. Also, information indicating that an NAN device can establish a PostNAN data link by Wi-Fi Direct is being searched may be included in the Subscribe message. By transmission of the Subscribe message, the NAN device 101 becomes capable of searching for an NAN device in the NAN cluster 104 that is capable of executing the print service.

The NAN control unit 202 of the NAN device 101, via the communication unit 306, determines whether or not it received a Publish message in which the Service ID corresponding to the print application service in the SDF is designated as a response to the transmitted Subscribe message (step S603). When the NAN control unit 202 determines that the Publish message was received via the communication unit 306 (Yes in step S603), it determines whether communication parameters are already shared with the other NAN device that transmitted the Publish message. Note that because the processing of step S604 is the same as the processing of step S403 of FIG. 4, description thereof is omitted.

If the NAN control unit 202 determines that the communication parameters are already shared with the other NAN device (Yes in step S604), it transmits an Invitation Request using an NAN Follow-up message via the communication unit 306 (step S608). By this, the NAN device 101 requests construction of a network with the other NAN device. Note that the NAN control unit 202 is able to transmit the Invitation Request by adding a P2P attribute used in a P2P Invitation Request defined in Wi-Fi Direct to the SDF. In a case when the NAN device, having received the Invitation Request, accepts (permits) the request to construct the network, it replies with an Invitation Response that stores a value indicating success in the Status using a Follow-up message. Note that it is possible to transmit the Invitation Response by adding a P2P attribute used in a P2P Invitation Response defined in Wi-Fi Direct to the SDF.

Note that information of a network identifier (P2P Group BSSID) connected to in the past and a P2P group identifier (P2P Group ID) are stored in a P2P Invitation Request or a P2P Invitation Response. By this, it becomes possible to use the P2P Invitation Request or the P2P Invitation Response in negotiation for constructing the same network once again.

In a case when the NAN control unit 202 of the NAN device 101 determines that an Invitation Response having a Status in which a value indicating success is stored was received via the communication unit 306 (Yes in step S609), the processing advances to step S610. In step S610, the Wi-Fi Direct control unit 203 executes Wi-Fi Direct connection processing. After completion of the connection processing, the communication control unit 204 of the NAN device 101 starts data communication by the application (step S611). Also, the application control unit 205 performs control for executing an application.

Meanwhile, in a case when the NAN control unit 202 determines that an Invitation Response having a Status in which a value indicating success is stored was not received via the communication unit 306 (No in step S609), the processing advances to step S605. Note that because the processing of step S605 to step S607 is the same as the processing of step S405 to step S407 and step S411 of FIG. 4, description thereof is omitted. Note that in the case of No in step S609, the NAN control unit 202 may transmit the Invitation Request once again via the communication unit 306. Also, in a case when parameters that can be used otherwise exist, the NAN control unit 202 may transmit an Invitation Request having different contents. By this, the NAN device 101 may wait for a fixed period to receive the Invitation Response that has a Status in which a value indicating success is stored.

In this way, by receiving an Invitation Request or Response, the NAN device becomes capable of executing a negotiation of parameters used in the PostNAN prior to transition to the PostNAN.

Also, in a case when the NAN control unit 202 determines that the communication parameters have not already been shared with the other NAN device that transmitted the Publish message (No in step S604), the processing advances to step S605. Because, as described above, the processing of step S605 to step S607 is the same as the processing of step S405 to step S407 of FIG. 4, description thereof is omitted.

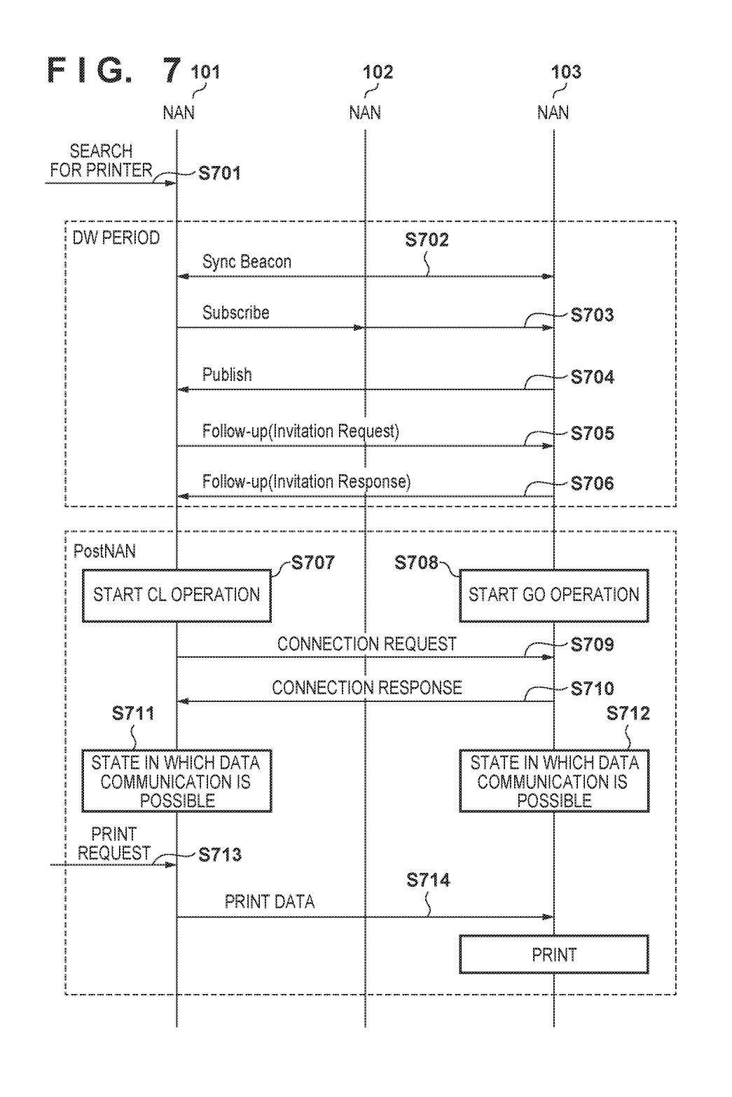

In FIG. 7, a flow of a sequence of service discovery, an establishment of a data link by Wi-Fi Direct, and application communication processing in the present embodiment is illustrated in a sequence diagram.

The processing of step S701 to step S704 is the same as the processing of step S501 to step S504 of FIG. 5, and description thereof is omitted. In step S705, the NAN device 101 transmits the Invitation Request to the NAN device 103 using a Follow-up message. In the Invitation Request, as mentioned previously, a network identifier used when the NAN device 101 connected with the NAN device 103 in the past is stored. The NAN device 103 determines that reconstruction of the network is possible based on the information of the network identifier or the like, and transmits to the NAN device 101 an Invitation Response in which a value representing success is stored in the Status using a Follow-up message. The NAN device 101 and the NAN device 103 start operation in their respective past roles when the negotiation by Invitation Request/Response ends (step S707 and step S708). For example, the NAN device 103 that was operating as GO in the past Wi-Fi Direct connection starts operation as GO once again. The processing of step S709 to step S714 thereafter is the same as the processing of step S506 to step S511 of FIG. 5, and description thereof is omitted.

Note that in the present embodiment, a case when the NAN device 103, having received a Subscribe message, transmits a Publish message was described as an example. Limitation is not made to this example, and application of the present embodiment is possible even if the NAN device 103 transmits a Publish message autonomously.

In this way, by virtue of the present embodiment, since both NAN devices determine the network to construct again by negotiation in advance, it becomes possible to execute processing to connect using communication parameters that are unique to each other. For this reason, it becomes possible to prevent execution of connection processing using communication parameters that are different to each other, and efficient connection becomes possible.

### Third Embodiment

In the present embodiment, after receiving a Subscribe message from the NAN device 103 which is a Publisher, a list that combines Service IDs used when providing a service in the past and information identifying communication parameters used at that time is generated. The NAN device 103 transmits the generated list to the NAN device 101 which is the Subscriber, and references the information designated from the NAN device 101 after that to decide the communication parameters to use in the PostNAN. Hereinafter, points that are different to the first and second embodiments are described.

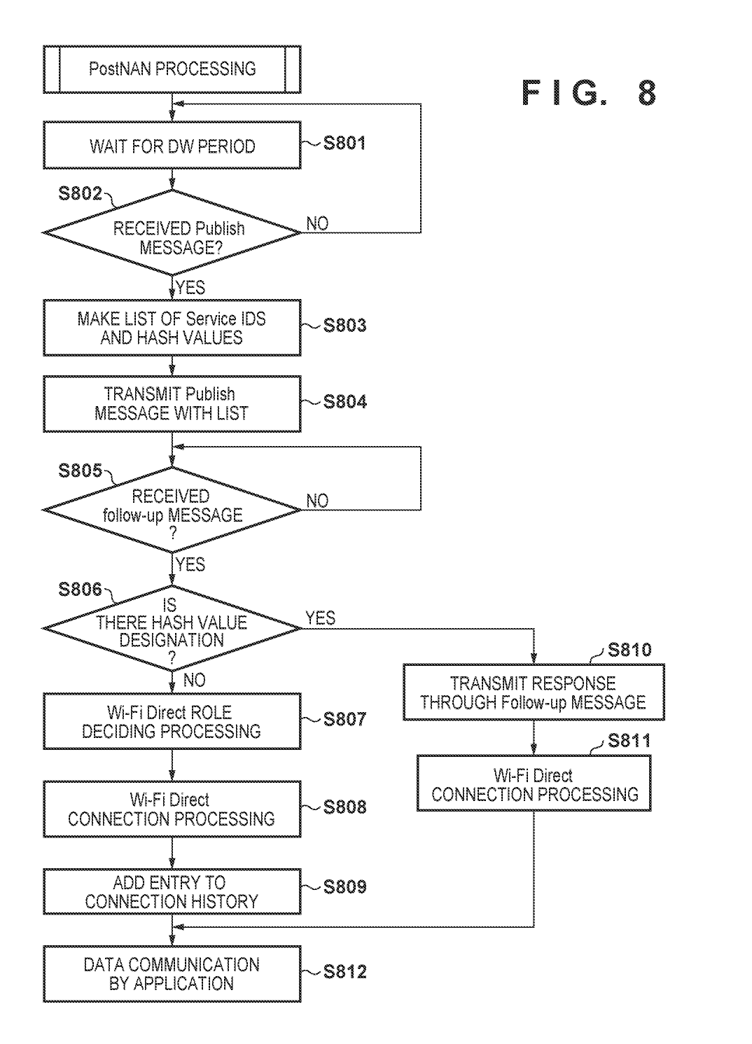

Next, with reference to FIG. 8, processing in which the NAN device 103 requests a PostNAN communication link establishment is described. FIG. 8 is a flowchart of communication link establishment processing in the present embodiment. Note that it is assumed that the NAN device 103 as a Publisher stores in the storage unit 301 a combination of a Service ID used when providing a service in the past and communication parameters used at that time as connection history.

Because the processing of step S801 to step S802 is the same as the processing of step S601 to step S602 of FIG. 6, description thereof is omitted. Next, the NAN control unit 202 of the NAN device 103 generates a list of Service IDs and hash values calculated from the communication parameters (step S803). The NAN control unit 202 of the NAN device 103 can generate the list of Service IDs and hash values from the Service IDs used when providing the service in the past and the information of the communication parameters used at those times which are stored in the storage unit 301. Using this list, the NAN device 103 becomes capable of recognizing what service to provide with what communication parameters. Also, by handling the communication parameters with hash values, the NAN device 103 becomes capable of identifying communication parameters uniquely in relation to a device that it connected to in the past, while guaranteeing confidentiality of an encryption key or the like. Note that hash values were described as an example, but it is possible to use a P2P group identifier. The NAN control unit 202 of the NAN device 103, when it generates the list, transmits the Publish message added to the list via the communication unit 306 (step S804).

Next, the NAN device 103 waits to receive a Follow-up message (step S805). In a case when the NAN control unit 202 of the NAN device 103 determines that a Follow-up message was received via the communication unit 306 (Yes in step S805), it determines whether or not there is a designation of a hash value in the message (step S806). In a case when it is determined that there is a hash value designation (Yes in step S806), the NAN control unit 202, via the communication unit 306, transmits a response indicating that performing communication by the communication parameters corresponding to the designated hash value is permitted (step S810).

When the NAN control unit 202 transmits a response, the Wi-Fi Direct control unit 203 uses the communication parameters corresponding to the designated hash value to execute Wi-Fi Direct connection processing (step S811). After completion of the connection processing, the communication control unit 204 of the NAN device 103 starts data communication by the application (step S812). This application service is a service of a Service ID corresponding to the communication parameter in the generated list.

Meanwhile, in a case when it is determined that there is no hash value designation in step S806 (No in step S806), the Wi-Fi Direct control unit 203 of the NAN device 103 executes Wi-Fi Direct role deciding processing with the NAN device 101 (step S807). The processing of step S807 to step S809 is the same as the processing of step S405 to step S407 of FIG. 4, and description thereof is omitted.

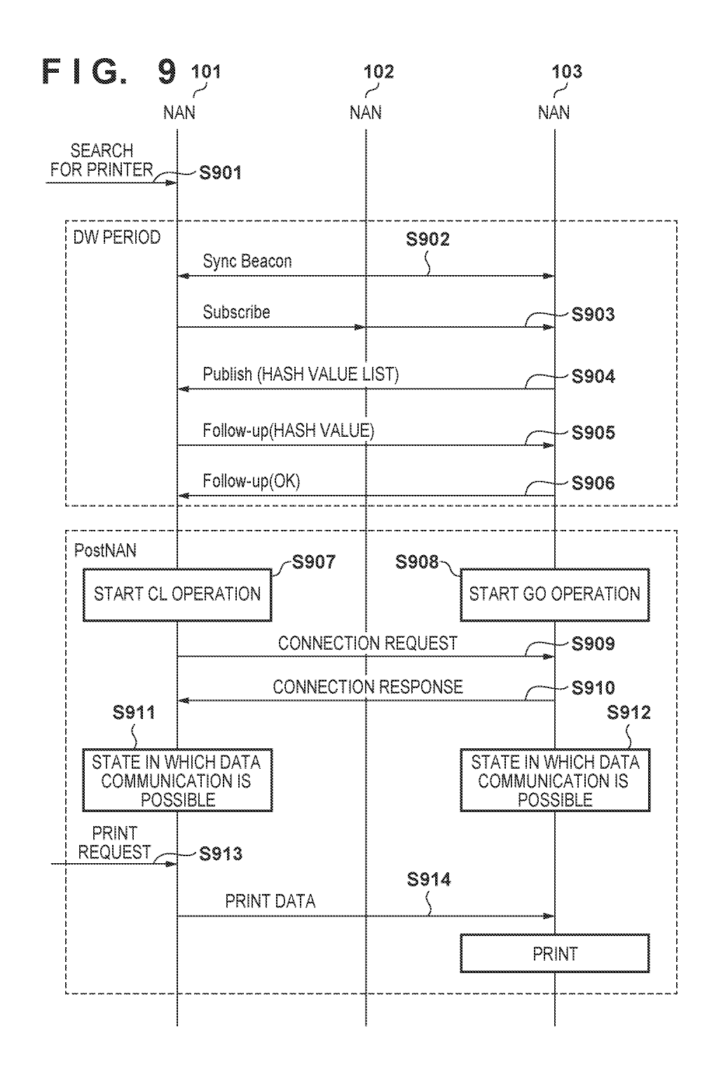

In FIG. 9 in the present embodiment, a flow of a sequence of service discovery, an establishment of a data link by Wi-Fi Direct, and application communication processing is illustrated in a sequence diagram.

The processing of step S901 to step S903 is the same as the processing of step S501 to step S503 of FIG. 5, and description thereof is omitted. In step S904, the NAN device 103 generates a list of a Service IDs and hash values calculated from the communication parameters and transmits a Publish message to which the list is added. The NAN device 101, having received the Publish message, transmits a Follow-up message in which the hash value is designated (step S905). The NAN device 103, having received the Follow-up message in which a hash value is designated, transmits a Follow-up message indicating that communication using the communication parameters corresponding to the designated hash value is permitted (OK) (step S906). The processing of step S907 to step S914 is the same as the processing of step S707 to step S714 of FIG. 7, and description thereof is omitted.

Note that while in the present embodiment, a case in which the NAN device 103, having received the Subscribe message, transmits the Publish message is described as an example, application to a case in which the NAN device 103 transmits the Publish message autonomously is also possible.

In this way, by virtue of the present embodiment, because both NAN devices select the network to construct once again from the list of the Service IDs and communication parameters, it becomes possible to prevent a connection error that could occur if an unintended reconstruction of network is requested. Therefore, it becomes possible to shorten the time until the communication parameters used mutually are decided, and so connectability improves.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-145695, filed Jul. 25, 2016, which is hereby incorporated by reference herein in its entirety.

What is claimed is:

1. A communication apparatus, comprising:
a determination unit configured to, in a first period which is a Discovery Window defined in Neighbor Awareness Networking (NAN), in a case when a signal for searching for a predetermined service or a reply corresponding to the signal is communicated with another communication apparatus, determine whether there is a communication parameter that was shared with the other communication apparatus;
a data link control unit configured to, in a case when it is determined by the determination unit that there is a communication parameter shared with the other communication apparatus, use the shared communication parameter to establish a data link with the other communication apparatus; and
an execution unit configured to, in a second period including a period different to the first period, execute the predetermined service by a data link established by the data link control unit.

2. The communication apparatus according to claim 1, comprising
a sharing unit configured to, in a case when it is determined by the determination unit that there is no communication parameter shared with the other communication apparatus, execute sharing processing for sharing with the other communication apparatus a communication parameter for establishing a data link, wherein
in a case when it is determined by the determination unit that there is no communication parameter shared with the other communication apparatus, the data link control unit uses the communication parameter shared by sharing processing executed by the sharing unit to establish a data link with the other communication apparatus.

3. The communication apparatus according to claim 1, wherein the data link control unit establishes a data link with the other communication apparatus in accordance with processing defined in Wi-Fi Direct.

4. The communication apparatus according to claim 3, wherein when the communication apparatus operates as GO (Group Owner) in Wi-Fi Direct, the communication apparatus communicates, with the other communication apparatus, information of the predetermined service and information of the second period.

5. The communication apparatus according to claim 4, wherein in response to a connection request received after communication of the information of the predetermined service and the information of the second period, the execution unit executes the predetermined service.

6. The communication apparatus according to claim 3, wherein the communication apparatus transmits to the other communication apparatus a list that has information that identifies a service executed in the past and information that identifies a communication parameter used for execution of the service.

7. The communication apparatus according to claim 6, wherein in a case when information identifying the communication parameter is included in the information received from the other communication apparatus after the list is transmitted, the data link control unit operates as GO.

8. The communication apparatus according to claim 7, wherein in a case when a connection request is received when the data link control unit is operating as GO, the execution unit executes the predetermined service.

9. The communication apparatus according to claim 1, wherein the data link control unit operates as CL (Client) in Wi-Fi Direct.

10. The communication apparatus according to claim 9, wherein in response to a P2P Invitation Response received from the other communication apparatus after transmitting a P2P Invitation Request, the data link control unit operates as CL.

11. The communication apparatus according to claim 10, wherein in a case in which the data link control unit, when operating as CL, after having transmitted a connection request to the other communication apparatus, receives a response indicating that the connection request is permitted from the other communication apparatus, the execution unit executes the predetermined service.

12. A method of controlling a communication apparatus, comprising:
in a first period which is a Discovery Window defined in Neighbor Awareness Networking (NAN), in a case when a signal for searching for a predetermined service or a reply corresponding to the signal is communicated with another communication apparatus, determining whether there is a communication parameter that was shared with the other communication apparatus;
in a case when it is determined that there is a communication parameter shared with the other communication apparatus, using the shared communication parameter to establish a data link with the other communication apparatus; and
in a second period including a period different to the first period, executing the predetermined service by a data link established by the data link control unit.

13. A non-transitory computer-readable storage medium storing a computer program for causing a computer to execute a control method of a communication apparatus, the method comprising:
in a first period which is a Discovery Window defined in Neighbor Awareness Networking (NAN), in a case when a signal for searching for a predetermined service or a reply corresponding to the signal is communicated with another communication apparatus, determining whether there is a communication parameter that was shared with the other communication apparatus;
in a case when it is determined that there is a communication parameter shared with the other communication apparatus, using the shared communication parameter to establish a data link with the other communication apparatus; and
in a second period including a period different to the first period, executing the predetermined service by a data link established by the data link control unit.
